(19) United States
(12) Patent Application Publication
(10) Pub. No.: US 2008/0108367 A1
(43) Pub. Date: May 8, 2008

(54) System and method for supporting multiple technologies in a wireless communication cell

(75) Inventors: Alireza Afrashteh, Great Falls, VA (US); Masoud Olfat, Clarksville, MD (US); Douglas A. Hyslop, Vienna, VA (US); Rajesh M. Gangadhar, Ashburn, VA (US)

Correspondence Address: SPRINT NEXTEL CORPORATION, 6391 SPRINT PARKWAY, MAILSTOP: KSOPHT0101-Z2100, OVERLAND PARK, KS, 66251-2100, US

(73) Assignee: Nextel Communications, Inc., Reston, VA (US)

(21) Appl. No.: 11/594,168

(22) Filed: Nov. 8, 2006

(51) Int. Cl. H04Q 7/20; H04M 1/00

(52) U.S. Cl. 455/452.2; 455/561

(57) ABSTRACT

Systems and methods for supporting multiple wireless communication technologies within a cell are provided. A base station can transmit a second wireless communication technology in a smaller coverage than the coverage of the first wireless communication technology, thereby producing an underlay-overlay cell radiation pattern. Whether a mobile station communicates with the base station using the first or second wireless communication technology can be based on a comparison of signal quality measures for the mobile station, or any other performance metric with a fixed or dynamic threshold.

### BACKGROUND OF THE INVENTION

Wireless communication technology has advanced over the years, starting with analog communications technology and advancing to digital communications technology. This has paved the way for development of various wireless communication technology standards. These standards define air interface signaling protocols, duplexing modes of operation, core network architecture, multiple access technologies, and the like.

Each wireless communication standard has advantages and disadvantages relative to other wireless communication standards. Additionally, wireless communication standards require years to develop. This development may occur in stages, where interim standard drafts are issued allowing some features, leaving other features to additional interim drafts or the final standard.

### SUMMARY OF THE INVENTION

Recognizing the advantages and disadvantages of different wireless communication technologies and the fact that standards for these technologies may be in various stages of development, the present invention provides systems and methods in which a mobile station communicates with a base station using different wireless communication technologies. A base station can include functionality for supporting a first and second wireless communication technology.

Whether a mobile station communicates with the base station using the first or second wireless communication technology is based on a comparison of signal quality measures for the mobile station or other metrics with a threshold. The threshold can be fixed, or it can be dynamic. A dynamic threshold can be dynamic per-mobile station or for all mobile stations. The dynamic threshold can be set based on a type of communication service employed by the mobile station (and any associated Quality of Service (QoS)) and/or the loading of each of the first and second wireless communication technologies of the base station.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 is a block diagram of an exemplary wireless communication network in accordance with the present invention;

FIG. 2 illustrates a plurality of wireless communication cells in accordance with exemplary embodiments of the present invention; and

FIG. 3 is a flow diagram of an exemplary method in accordance with the present invention.

### DETAILED DESCRIPTION OF THE PREFERRED EMBODIMENTS

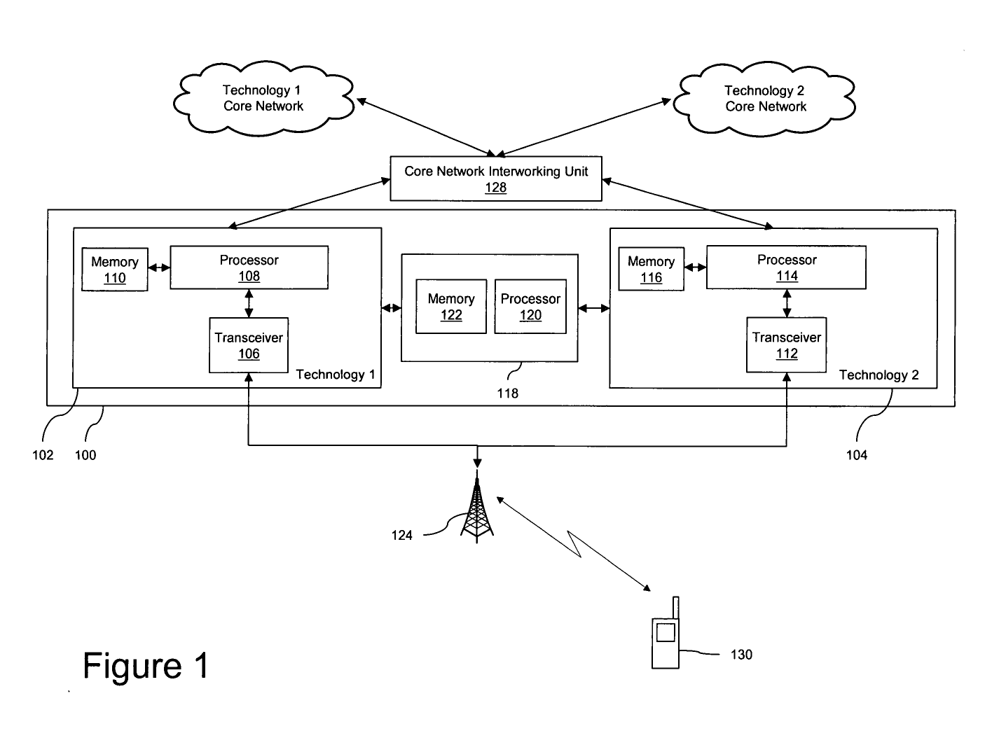

FIG. 1 is a block diagram of an exemplary wireless communication network in accordance with the present invention. The network includes a base site 100 with a first base station 102 operating according a first wireless communication technology and a second base station 104 operating according to a second wireless communication technology. First and second base stations 102 and 104 can be located on the same base station tower, for example, being implemented using different base station cards. Mobile station 130 communicates with base site 100 via either one antenna block with antenna elements for different frequency bands 124 or multiple antennas for different frequency bands.

The first base station 102 includes one or more transceivers 106, processor 108 and memory 110. The second base station 104 includes one or more transceivers 112, processor 114 and memory 116. Base site 100 also includes an interworking unit 118, which is coupled to base stations 102 and 104. Interworking unit 118 includes processor 120 and memory 122 and translates messages between the base stations. Base stations 102 and 104 are coupled to one or more antennas 124. Base stations 102 and 104 are also coupled to core network interworking unit 128, which in turn is coupled to core networks for technologies 1 and 2. If the network architecture used in the two technologies are not the same, then interworking unit 128 manages signaling and session transfer between the two technologies. Interworking unit 128 can be an IP-3G convergence component to close the gap between the network architectures of technology 1 (e.g., a 3G-based core network) and technology 2 (e.g., a flat IP core network).

The different wireless communication technologies of base stations 102 and 104 can employ different air interface protocols, duplexing modes of operation, multiple access technologies and/or signaling protocols. For example, base station 102 can operate according to EV-DO technology in 1.9 GHz (PCS) frequency band that employs single carriers modulation for its air interface protocol, frequency division duplexing (FDD) as the duplexing mode of operation, CDMA as a multiple access protocol and associated signaling protocol, while base station 104 can operate according to WiMAX or 3G-LTE technologies in 2.5 GHz frequency band, using OFDM as the air interface protocol, time division duplexing (TDD) as the duplexing mode of operation, OFDMA as a multiple access protocol and WiMAX or 3G-LTE signaling protocols. Other features that may be different between two technologies include handoff protocols, high mobility support, convenience to employ advanced antenna technologies (e.g., multiple input multiple output (MIMO) and beamforming), coverage area, ranging, power control, access mechanisms and the like. Although particular air interface protocols, duplexing modes of operation, multiple access technologies and signaling protocols have been identified for existing wireless communication standards, the present invention can employ any combination of air interface protocols, duplexing modes of operation, multiple access technologies and signaling protocols. Regardless of the signaling protocols employed, each of the core networks for technologies 1 and 2 will operate according to the signaling protocols of one of the base stations 102 and 104, as will be described in more detail below.

Although FIG. 1 illustrates the use of different processors and memories for the first and second wireless communication technologies, base site 100 can employ one or more common processors and/or memories to control both wireless communication technologies.

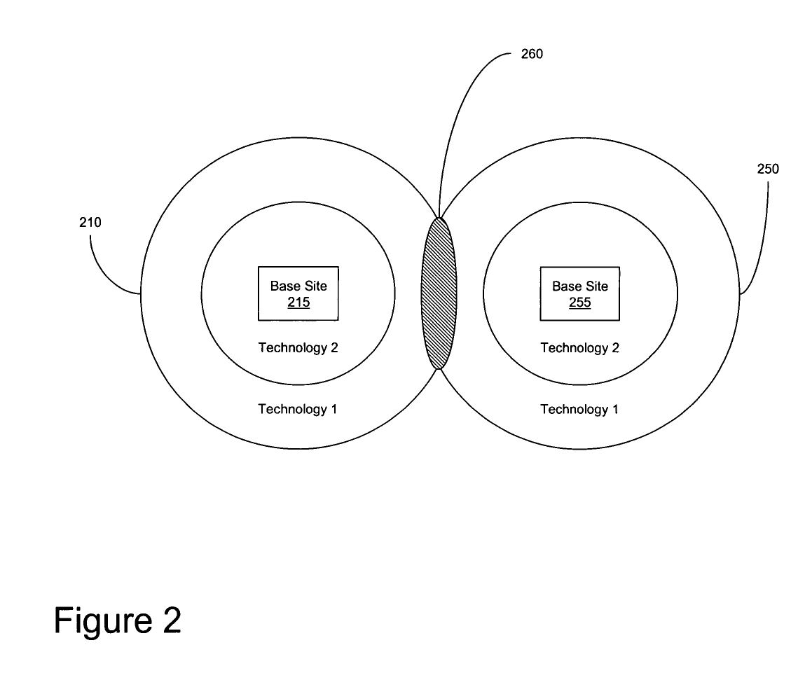

FIG. 2 illustrates a plurality of wireless communication cells in accordance with exemplary embodiments of the present invention. Cell 210 includes base site 215, and cell 250 includes base site 255. Base sites 215 and 255 each can include all of the components of base site 100. Area 260 is an area of overlap in coverage of the first wireless communication technologies for base stations 215 and 255. The first wireless communication technology can be a code division multiple access-based (CDMA) technology and the second wireless communication technology can be an OFDMA-based technology. Within a particular cell communications for the first and second technologies can be performed at the same or different power levels, the particular power levels being selected based on the appropriate link budget. The different circles in FIG. 2 represent the areas in which traffic channel communications are supported for the first and second wireless communication technologies are conceptual, and are the result of the selection of intra- and inter-cell handoff thresholds, which is described in more detail below.

The present invention uses two wireless communication technologies in an underlay-overlay arrangement as illustrated in FIG. 2 in order to leverage the strengths of each of these technologies while addressing the weaknesses of each technology. The advantages of the present invention relative to a single technology deployment is apparent considering performance metrics such as sector capacity, coverage, and mobility management. Specifically, OFDMA-based technologies are more effective at mitigating intra-cell interference among users than CDMA-based technologies, which suffer from self-interference and appear to provide lower peak data rates. OFDMA-based technologies also provide high spectral efficiencies in environments that suffer from multipath and frequency selective fading. Therefore, by employing OFDMA-based technologies at radial distances closer to the cell center, the present invention leverages the higher throughput of these technologies.

OFDMA-based technologies typically suffer from a higher level of inter-cell interference than CDMA-based technologies at the cell (or sector) edge, and the throughput achieved by CDMA-based technologies does not degrade as significantly with dropping signal quality (e.g., near the cell edge) as do for OFDMA-based technologies. Consequently, capacity is enhanced by leveraging OFDMA-based technologies whose throughput improvements result from wider channel bandwidths and better performance in high SNR environments. Accordingly, by employing CDMA-based technologies at radial distances farther from the cell center, the present invention addresses the inter-cell interference weakness of OFDMA-based technologies while taking advantage of the higher throughputs at lower signal quality levels that may be achieved using CDMA-based technologies towards the cell edges.

As most of OFDMA-based technologies are designed for data-centric networks, mobility management is normally less mature than those of CDMA-based technologies. CDMA-based standards have been evolving over the years, and their mobility management capabilities are quite mature and can support a low handoff latency and low packet error rate during the handoff. For example, the air interface handoff mechanism in EV-DO is based on Fast Base Station Switch (FBSS) in the downlink and Soft HandOff (SHO) or Macro Diversity HandOff (MHDO) in the uplink. These schemes can support handoff latencies of about 30 ms, and very low packet error rate due to MHDO. In the uplink, using MHDO, more than one base station receives the data traffic and the one with higher SINR transmits the data to the upper layers. With FBSS, the mobile station maintains a list of candidate neighboring base stations for handover in a diversity set, and performs the association, physical layer burst identification, authentication, and possible registration with those neighboring base stations. If the received SINR of one of these base stations is better than the one received from the current serving base station, the mobile station initiates the handoff. However, since many steps required for completion of a successful handoff are completed during diversity set selection/update, the handoff latency is significantly reduced compared to a hard handover mechanism (Break Before Make). Although both FBSS and MHDO have been introduced in some candidate technologies for 2.5 GHz spectrum such as WiMAX, due to complexities in the network layer these features will not be implemented in the first phase of deployment. Accordingly, by employing CDMA-based technologies at radial distances farther from the cell center, the present invention leverages the mature mobility management of these technologies. Exemplary embodiments of the present invention employ the first wireless communication technology (i.e., the CDMA-based technology) for mobility management.

Because inter-technology handovers are performed only within a cell (i.e., only for intra-cell handover), context transfer issues related to the two technologies can be handled completely within the base station, thereby eliminating any changes to the core network(s) for these handovers.

The overlay-underlay arrangement of the present invention also takes advantage of the improved link budgets provided by CDMA-based technologies compared to OFDMA-based technologies. These improved link budgets are attributable to better performance in an interference-dominated environment, smaller channel bandwidths that provide lower noise bandwidth, and higher CDMA processing gain compared to OFDMA subchannelization gains. Another important aspect is the spectrum band proposed for the two technologies. A technology deployed at a lower frequency may take advantage of more favorable RF propagation, and hence an improved coverage relative to a higher frequency band.

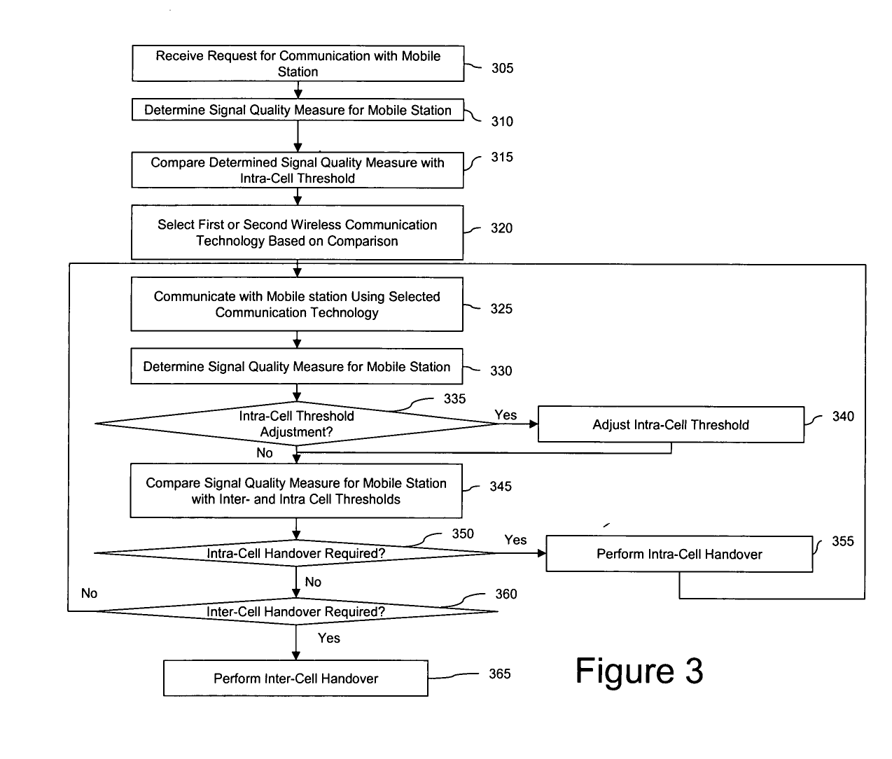

FIG. 3 is a flow diagram of an exemplary method in accordance with the present invention. Assume that a mobile station is located within the coverage area of cell 210 and that a request for communication with the mobile station is received by base station 215 (step 305). This request for communication can be initiated by the mobile station or can be a communication destined for the mobile station. In accordance with exemplary embodiments of the present invention, the mobile station employs control channels of the first wireless communication technology (e.g., the CDMA-based technology) for monitoring incoming page requests and transmitting random access requests for traffic channel assignments.

A signal quality measure for the mobile station is determined and compared with an intra-cell threshold (steps 310 and 315). The signal quality measure determination and threshold comparison can be performed by the mobile station, base station or any other infrastructure component. When the mobile station performs the threshold comparison the base station can communicate the threshold over control channels. The signal quality measure can be, for example, a physical or effective signal-to-interference-plus-noise (SINR) ratio at the mobile station (i.e., downlink measurements) or at the base station (i.e., uplink measurements).

The intra-cell threshold can be adjusted on a per-mobile basis, for example, based on a type of communication service associated with the communication request, quality of service (QoS) parameters, as well as the determined signal quality measure. For example, if the communication service is Voice over Internet Protocol (VoIP), or other real-time applications, and the loading of the base station is relatively light, then a lower threshold (compared to data traffic) may be selected because QoS is more important than throughput for this service. Alternatively, in order to better balance traffic loading and ensure minimal handover disruption for low-bandwidth application, such as VoIP, these applications can be served entirely by the first wireless communication technology, such service being controlled by setting the threshold accordingly. The present invention is particularly well-suited for high-bandwidth applications such as file transfer or streaming media, by leveraging the higher bandwidth of technology 2 in good signal conditions and taking advantage of the mobility management strengths of technology 1.

One of the first or second wireless communication technologies is then selected for communication based on the comparison, and the mobile station communicates with the base station using the selected communication technology (steps 320 and 325).

Periodically during the communications between the mobile station and base station a signal quality measure is determined for the mobile station (step 330). The signal quality measure can be performed by the mobile station or base station. Next, it is determined whether the intra-cell threshold requires adjustment. When a per-mobile station intra-cell threshold is employed, the adjustment can be due to a change in the type of communication service being employed by the mobile station. Additionally, or alternatively, the intra-cell threshold can be adjusted to control base station loading of the first and second communication technologies. For example, when the second communication technology is at or near capacity, the threshold can be adjusted to move some mobile stations over to the first communication technology, and vice versa.

When the intra-cell threshold requires adjustment (“Yes” path out of decision step 335), it is adjusted (step 340). Determination of whether the intra-cell threshold requires adjustment and the actual adjustment can be preformed by the base station of the supporting communication technology, interworking unit 118 or any other infrastructure component. When there is no adjustment required for the intra-cell threshold (“No” path out of decision step 335), or after the threshold has been adjusted (step 340), then the signal quality measure for the mobile station is compared with inter-cell and intra-cell thresholds (step 345).

When the comparison indicates that intra-cell handover is required (“Yes” path out of decision step 350), then intra-cell handover is performed (step 355) and the mobile station continues to communicate with the base station (step 325). Context transfer between the technologies, as well as any other message translation, can be performed by interworking unit 118. If the mobile station's current communication is a multicast broadcast service (MBS), then the base station may elect not to perform a handover, but instead would continue to provide this communication to the mobile station using the same technology over the entire cell coverage area or multicast/broadcast the same information using both wireless communication technologies. Th is is due to the fact that the mobile station is not actually registered to a particular base station for multicast/broadcast services, and receives the packets from multiple base stations, and therefore no handover is needed. Moreover, normally OFDMA-based technologies are known to be more appropriate for these services, and therefore no intra-cell (or inter-technology) handover is required. It should be recognized that no threshold adjustment is performed on a per-mobile basis for multicast/broadcast services, as communication mechanisms cannot be adjusted based on the mobile station's SINR or link quality.

When the comparison indicates that inter-cell handover is required (“Yes” path out of decision step 360), then inter-cell handover is performed and the mobile station begins communicating with the new base station (step 365). This may occur when the mobile station is located in the area 260 in which the coverage of base stations 215 and 255 overlap. When an intra-cell or inter-cell handover is not required (“No” path out of decision steps 350 and 360), then the base station and mobile station continue to communicate based on the selected wireless communication technology (step 325).

In the method described in connection with FIG. 3 a mobile station's signal quality is compared to intra- and inter-cell thresholds. The present invention can also be employed with other metrics for comparison (e.g., load balancing) to these thresholds. These other metrics can be employed instead of or in addition to the mobile station signal quality measurements. Moreover, the comparison metric for determining whether an inter-cell handover is required could be the same or different than that used for intra-cell handover.

In accordance with exemplary embodiments of the present invention, mobile stations monitor only technology 1 for idle mobility management, and accordingly paging and random access requests are placed on technology 1's existing control channel mechanisms. Traffic channel selection and allocation between the two technologies is performed based on the method of FIG. 3.

It should be recognized that the inter- and intra-cell handovers described above can be any type of handover, including, but not limited to, mobile assisted handover (MAHO), base station assisted handover, mobile-initiated handover, base station-initiated handover, and or the like. Moreover, although exemplary embodiments have been described as employing CDMA-based technologies for mobility management, as OFDMA-based technologies mature, either or both CDMA- and OFDMA-based technologies can be employed for mobility management.

The impact of the exemplary embodiment of this invention on the equipment complexities is minimal. The mobile stations need to support multiple technologies (technologies 1 & 2). As for the base stations, the coordination needed between the two technologies is minimal, as there is no time interval over which the two technologies simultaneously communicate with the mobile station. The main requirement is the addition of required signaling to initiate and handle the technology handoff and the context transfer during the switch. However, since both technologies reside on the same base site (tower), the context transfer does not traverse through the core network, and therefore does not add any additional complexity to the system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of communicating with a mobile station, the method comprising the acts of:
determining a signal quality measure for the mobile station;
comparing the signal quality measure with a threshold;
selecting one of a first or second wireless communication technology based on the comparison; and
communicating, by a base station with the mobile station, using the selected one of the first or second wireless communication technology.

2. The method of claim 1, wherein the threshold is an intra-cell threshold, and the method further comprising the act of:
determining whether to adjust the intra-cell threshold; and
adjusting the intra-cell threshold.

3. The method of claim 2, wherein the intra-cell threshold is adjusted based on parameters related to the mobile station.

4. The method of claim 3, wherein the parameters related to the mobile station include a communication service employed by the mobile station.

5. The method of claim 2, wherein the intra-cell threshold is adjusted based on parameters related to the mobile station and to an impact to other mobile stations' communication.

6. The method of claim 5, wherein the impact to other mobile stations' communications include loading of the base station.

7. The method of claim 1, wherein the selection of one of the first or second wireless communication technologies is also based on a communication service employed by the mobile station.

8. The method of claim 1, further comprising the acts of:
determining another signal quality measure for the mobile station;
comparing the another signal quality measure with another threshold; and
determining whether to handover the mobile station based on the comparison of the another signal quality measure with the another threshold.

9. The method of claim 8, wherein the threshold and the another threshold are intra-cell thresholds.

10. The method of claim 9, further comprising the act of:
handing-over the mobile station from one of the first or second wireless communication technologies to the other wireless communication technology, wherein the handover is an intra-cell handover.

11. The method of claim 8, wherein the threshold is an intra-cell threshold and the another threshold is an inter-cell threshold.

12. The method of claim 11, wherein the mobile station handover is from the first wireless communication technology of one base station to the first wireless communication technology of another base station.

13. A base site comprising:
a first base station, the first base station includes a transceiver; and
a processor coupled to the transceiver to control the transceiver to communicate with a first set of mobile stations according to a first wireless communication technology;
a second base station, the second base station includes
a transceiver; and
a processor coupled to the transceiver to control the transceiver to communicate with a second set of mobile stations according to a second wireless communication technology,
wherein the first set of mobile stations are located at radial distances farther from the base site than the second set of mobile stations.

14. The base site of claim 13, wherein the first wireless communication technology is an orthogonal frequency division multiple access (OFDMA)-based technology and the second wireless communication technology is a code division multiple access (CDMA)-based technology.

15. The base site of claim 13, further comprising:
an interworking unit coupled to the first and second base stations.

16. The base site of claim 15, wherein the interworking unit exchanges messages between the first and second base stations during handover of a mobile station between the base stations.

17. The base site of claim 13, wherein the first and second base stations are base station cards arranged in a same base station tower.

18. The base site of claim 13, wherein different network architecture and core network protocols and signaling are used for the first and second wireless communication technologies.

19. The base site of claim 18, wherein the first and second base stations are coupled to a core network interworking unit that translates the network protocols and signaling among the two technologies.

20. A method of communicating with a mobile station, the method comprising the acts of:
determining a metric for the mobile station;
comparing the metric with a threshold;
selecting one of a first or second wireless communication technology based on the comparison; and
communicating, by a base station with the mobile station, using the selected one of the first or second wireless communication technology.

21. The method of claim 20, wherein the metric is a signal quality measure for the mobile station.

22. The method of claim 20, wherein the metric is based on a load on the base station.
